(19) United States
(12) Patent Application Publication
(10) Pub. No.: US 2008/0210269 A1
(43) Pub. Date: Sep. 4, 2008

(54) REMOVING UNWANTED FILM FROM WAFER EDGE REGION WITH REACTIVE GAS JET

(75) Inventors: William George America, Kingston, NY (US); Steven Hilton Johnston, Poughkeepsie, NY (US)

Correspondence Address: CANTOR COLBURN LLP - IBM FISHKILL, 20 Church Street, 22nd Floor, Hartford, CT, 06103, US

(73) Assignee: International Business Machines Corporation, Armonk, NY (US)

(21) Appl. No.: 12/107,115

(22) Filed: Apr. 22, 2008

Related U.S. Application Data
(62) Division of application No. 10/710,225, filed on Jun. 28, 2004.

(51) Int. Cl. B08B 5/00; B08B 13/00

(52) U.S. Cl. 134/99.1; 134/105

(57) ABSTRACT

Unwanted films can be eliminated by directing a stream of reactive gas(es) at reactive zone in an edge region of the wafer. The action of the reactive gas can be enhanced by heating the gas in a nozzle, immediately prior to the gas impinging on the wafer. The action of the reactive gas can also be enhanced by ultraviolet (UV) or infrared (IR) radiation directed at the reactive zone. The wafer is rotates so that the reactive zone traverses the entire edge region. Multiple gas/light delivery systems can cause gas and light to impinge on multiple reactive zones, both on the front side and on the back side of the wafer.

### CROSS-REFERENCE TO RELATED APPLICATIONS

This non-provisional U.S. patent application is a divisional of pending U.S. patent application Ser. No. 10/710,225, which was filed Jun. 28, 2004, and is assigned to the present assignee.

### BACKGROUND OF INVENTION

The invention relates to semiconductor device fabrication, and more particularly to techniques for removal of residual process films (e.g., polymeric and refractory films) and debris from the edge region (perimeter and bevel) of a semiconductor wafer.

Semiconductor wafers are typically round (circular, disc-like), usually having a diameter ranging from 150-350 mm and a thickness of 1-1.5 mm. Integrated circuit (IC) devices are formed in an interior “device area” on the front (or device) side of the wafer. The edge (perimeter) of the wafer is often beveled, typically at 45 degrees, the bevel extending approximately 0.5-1.0 mm from the edge of the wafer towards the center of the wafer. An “edge region” of the wafer includes the edge of the wafer, the bevel, and a small (e.g., 0.5-2.0 mm on the front side, 0.5-4.0 mm region on the back side) area within the bevel.

A semiconductor wafer that has been processed in a typical manner can have undesirable films and or residues on the perimeter or beveled edges of the wafer, in what is referred to herein as the “edge region” of the wafer. These films may result from a processing step during film deposition or as a consequence of a plasma etch process used to form three-dimensional features in the wafer, including vias or trenches. Frequently, the deposition of the film occurs across the full area of the device side of the wafer, the beveled edges and a small segment of the perimeter of the back side of the wafer. There are frequently several films deposited per device level. This film(s) deposition is often repeated numerous times for each level of the semiconductor manufacturing process. Consequently, these multiple layers which build up in the edge region can result in high film stress(es) which in turn fracture and result in shards or fragments of the films landing on the device side of the wafer. These unwanted pieces of foreign matter can result in unwanted defects in the device area of the wafer, reducing performance or device yield.

Frequently, the film to be removed is a by-product of a plasma etch process that deposits organocarbon-polymer organofluorocarbon-polymer on the front and back perimeter and bevel regions of the wafer. This film will also build up for each level or wafer processing and result in particulates being released onto the wafer as a result of inherent stress of the film. Particulates can cause opens in electrical connections and metal lines resulting in product fails. The need to remove excess deposits from the edge region of the wafer is understood by those skilled in the art.

Wet chemical spray processes have been used to remove polymeric films in the edge region but with limited success owing to limitation of reagents that can be used with acceptable selectivity to the films present. Special protective means are generally needed by wet processes to prevent unwanted chemical attack to device portion of the wafer.

Plasma processes have been created where the etch tool itself has been modified to remove unwanted films at the edge of the wafer. Most often the plasma power is applied through the full body of the wafer risking unwanted etching of the wafer or plasma induced damage. Also the plasma processes do not necessarily get to the bevel of the wafer where the unwanted films may have also been deposited.

“Wafer Edge Region Cleaning With A Torus-Shaped Capacitively Coupled Plasma” by Buil Jeon et al., Department of Physics, Korea Advanced Institute of Science and Technology (KAIST), Guseong-dong, Youseong-gu, Daejeon, Korea (hereinafter referred to as “Jeon”), discloses a torus-shaped Capacitively Coupled Plasma (CCP) source to remove harmful film layers and particles deposited on a wafer's edge, bevel and backside during film deposition or other semiconductor processes. A plasma is generated along 2 mm of an edge and 4 mm of a backside of a wafer. Therefore, films and particles can be removed from the wafer edge, bevel and backside without damaging patterns inside of a wafer.

Atmospheric plasma torches (also called plasma jets) have been devised that create streams of reactive gases to remove unwanted or sculpt films on the perimeter of wafers. These plasma torches are radio frequency (rf) powered as either capacitively coupled or inductively coupled. Since the plasmas are to operate at atmospheric pressure, large applied rf power is needed to create a reasonable concentration of reactive species in the flow stream out of the plasma. The reactive ions or activated species are limited to the lifetime that can be obtained by a plasma jet at atmospheric pressure. This is problematic; for example, while oxygen can be made reactive at atmospheric pressure the reactivity at room temperature is low. Thus the wafer needs to be heated to typically over 200° C. Heating can be carried out by heating the entire wafer or by using a high powered plasma jet, usually inductively coupled or DC arc discharge, and placing the edge of the wafer directly into the plasma jet. This may or may not be acceptable to other films on the wafer. Also, to remove films other than organic polymers requires gases that usually don not have lifetime sufficiently long outside the plasma to make them reactive with the film to be removed. Plasma jets also require large amounts of power and are often are difficult to hold stable at atmospheric pressure.

U.S. Pat. No. 6,546,938 discloses combined plasma/liquid cleaning of substrates, which includes the use of an atmospheric pressure plasma jet (APPJ). As noted therein, as part of the developed art in copper process technologies for silicon wafers, it has been shown that it is important to remove unwanted copper film deposits from the beveled edge of a wafer, as well as from the back side edge, and the front edge of the wafer (i.e., the so-called “edge exclusion” zone). The substrate is held and rotated by a chuck and an atmospheric pressure plasma jet (APPJ) places a plasma onto predetermined areas of the substrate. Subsequently liquid rinse is sprayed onto the predetermined areas. As discussed therein (FIG. 1), an APPJ for removal of copper films from the beveled edge of silicon wafers contains a flow of atomic chlorine formed by the reaction of the electrons in the plasma source, and the liquid rinse can be water, deionized or distilled. As discussed therein, centrifugal force from the rotation of the substrate assists in the removal of dissolved copper. As further discussed therein (FIG. 2), the substrate is retreated. A nozzle (17) sprays nitrogen or another drying gas onto substrate 11 before the treated section again encounters the APPJ. This is to assist drying of the section of substrate before retreatment, when required. Complete drying of the treated region normally is not required for operation. Simply removing the majority of the sprayed water solution usually is sufficient.

### SUMMARY OF INVENTION

The present invention provides a process wherein unwanted films deposited during dry etching or created by other semiconductor wafer fabrication processes may be eliminated and/or sculpted (e.g., reduced in thickness) to a preferred profile, by directing a stream of one or more reactive gas(es) at a predefined, small (with respect to the overall wafer) typically substantially circular area (“reactive zone”) which is typically at an edge portion (circumference, periphery, perimeter) of the wafer to remove part or all of the unwanted film, or one of a sequence (stack) of unwanted films. The action of the reactive gas can be enhanced by heating the gas immediately prior to the gas impinging on the wafer. The action of the reactive gas can also be enhanced by a beam of ultraviolet (UV) or infrared (IR) light directed at (e.g., focused upon) or adjacent to the reactive zone. The wafer may be rotated about its center so that the impinging reactive gas(es) and beam(s) of light act on an area encompassing the entire perimeter of the wafer; that is, the “edge region” of the wafer. Alternatively, the wafer can remain stationary, and the gas and light delivery system can be moved around the periphery of the wafer. Multiple gas/light delivery systems can cause gas and light to impinge on multiple reactive zones, both on the front side and on the back side of the wafer.

In accordance with one aspect of the invention, a method of treating an edge region of a semiconductor wafer comprises the steps of: directing a stream of at least one reactive gas along a gas-delivery axis at a reactive zone on a front side of the wafer, rotating the wafer about an axis of rotation so that the reactive zone travels circumferentially around the wafer until the entire edge region of the wafer has been treated by the at least one reactive gas, and heating the at least one reactive gas prior to directing the stream at the reactive zone on the wafer. Additionally, a beam of radiation selected from at least one of the group consisting of ultraviolet (UV) light and infrared (IR) light is directed at the wafer. The beam of radiation can be ultraviolet light which is directed at the reactive zone. The beam of radiation can be infrared light which is directed either at the reactive zone or at a position on the wafer which is rotationally slightly in advance of the reactive zone.

According to an additional aspect of the invention, at least one additional stream of gas can be directed at least one additional reactive zone on the wafer, and at least one additional beam of radiation can be directed at the at least one additional reactive zone or at a position on the wafer which is rotationally slightly in advance of the at least one additional reactive zone. The at least one additional reactive zone(s) can be on the front side or on the back side of the wafer, or both. When on the back side, the at least one additional reactive zones can be at the same or at different circumferential position(s) as the reactive zone(s) on the front side of the wafer, there can be a like or different number of additional reactive zone(s) as there are reactive zone(s), and the additional reactive zone(s) can be of substantially the same of a different size than the reactive zones.

The gas delivery axis may advantageously be inclined at an angle with respect to the axis of rotation of the wafer. Furthermore, the gas delivery axis may be tilted at an angle with respect to the axis of rotation.

Generally speaking, the reactive zone is relatively small in comparison with an overall area of the wafer, such as approximately 0.05% to 0.5% of a surface area of the wafer. Generally, the reactive zone is substantially a circular area. Usually, the reactive zone is located at an edge portion of the wafer. Typically, the wafer is disposed in a horizontal plane.

According to a further aspect of the invention, a spray nozzle assembly for treating an edge region of a semiconductor wafer comprises: a cylindrical pipe having a proximal end and a distal end, a tapered nozzle disposed at the proximal end of the cylindrical pipe, for directing reactive gas from the cylindrical pipe to a reactive zone on the wafer, a gas supply tube in fluid communication with the pipe, for supplying reactive gas to the cylindrical pipe, a resistive heater disposed about the cylindrical pipe, for heating the reactive gas, and a lens disposed at the distal end of the pipe for focusing a beam of radiation onto a reactive zone on the wafer. The nozzle may be made of V/IR transparent glasses, sapphire, or fused silica.

### BRIEF DESCRIPTION OF DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

FIG. 1 is a schematic side view of a technique for treating a semiconductor wafer, according to the invention.

FIG. 2 is a schematic top view of the technique of FIG. 1.

FIG. 3A is a schematic top view of an alternate embodiment of a technique for treating a semiconductor wafer, according to the invention.

FIG. 3B is a schematic top view of an alternate embodiment of a technique for treating a semiconductor wafer, according to the invention.

FIG. 4 is a view, partially in perspective and partially schematic, of apparatus for carrying out technique of the present invention.

### DETAILED DESCRIPTION

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

Materials (e.g., silicon dioxide) may be referred to by their formal and/or common names, as well as by their chemical formula. Regarding chemical formulas, numbers may be presented in normal font rather than as subscripts. For example, silicon dioxide may be referred to simply as “oxide”, chemical formula SiO2. For example, silicon nitride (stoichiometrically Si3N4, often abbreviated as “SiN”) may be referred to simply as “nitride”.

Exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

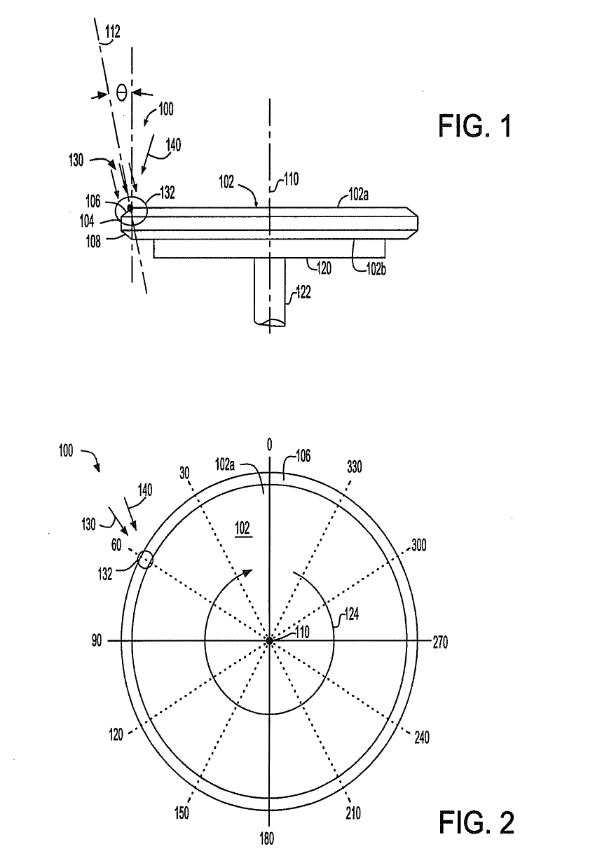

FIGS. 1 and 2 illustrate, schematically, apparatus 100 for treating an edge region of a semiconductor wafer 102, according to the invention. The wafer 102 has a diameter which is typically 150-300 mm, a thickness which is typically 0.5-2 mm, a front surface (side) 102a, a back side 102b, and an outer edge 104. The outer edge 104 is typically beveled. An upper bevel 106 is typically disposed at 45 degrees, extending approximately 1 mm towards the center of the wafer 102 from the outer edge 104 thereof. A lower bevel 108 is also typically at 45 degrees, extending approximately 1 mm towards the center of the wafer 102 from the outer edge 104 thereof. The wafer 102 is shown without any films or coatings, for illustrative clarity, but it will be understood that the present invention is specifically intended to treat (modify, remove, partially remove, sculpt, alter, etc.) material (e.g., unwanted film) located on the wafer, particularly at the edge region of the wafer, including at the bevels. In this example, the edge region includes the edge 104 of the wafer 102, the upper bevel 106, and a small (e.g., 0.5-2.0 mm on the front side of the wafer) area within the upper bevel. The edge region can also include the lower bevel 108, and a small (e.g., 0.5-2.0 mm on the front side of the wafer) area within the bevel.

An axis of rotation 110 is shown extending through the center of the wafer. In FIG. 1 it can be seen that the wafer 102 is disposed on (mounted to) a wafer chuck 120 which includes a spindle 122. The wafer 102 can be rotated about the axis of rotation 110, a full 360 degrees, as indicated by the arrow 124 in FIG. 2. In FIG. 2, various rotational positions of the wafer are labeled (0, 30, 60, 90, etc), as points of reference.

Although the wafer 102 is shown being disposed in a horizontal plane, it is within the scope of the invention that the wafer may be disposed in a vertical plane, or at any position between horizontal and vertical. However, it is generally easiest to hold the wafer in a horizontal plane, particularly as it rotates.

A stream 130 of one or more reactive gas(es), shown as 3 arrows in FIG. 1 and as one arrow in FIG. 2, is directed at a relatively small (in comparison with the overall surface area of the wafer) typically circular area (“reactive zone”) 132 which is typically at an edge portion of the wafer 102 to remove part or all of a film (not shown). This reactive zone 132 preferably includes the edge 104 of the wafer 102, the bevel 106, and a portion of the wafer immediately within the bevel 106, and may typically constitute approximately 0.05% to 0.5% of the overall wafer area. The reactive zone 132 may, for example, be defined by a circle approximately 0.5-5 mm in diameter, centered at the very edge of the wafer. In this example, the reactive zone is considered to be an area on the wafer, and is typically a circumferential segment of the edge region of the wafer.

In FIG. 2, the reactive zone 132 is shown at position “60” (60 degrees). Gas(es) are directed at this reactive zone 132 and, as the wafer is rotated, the reactive zone “travels” circumferentially around the periphery of the wafer until the entire edge region of the wafer has been treated by the reactive gas(es). A typical rate of rotation would be 1-10 rpm, and a typical wafer treatment would comprise one complete rotation of the wafer.

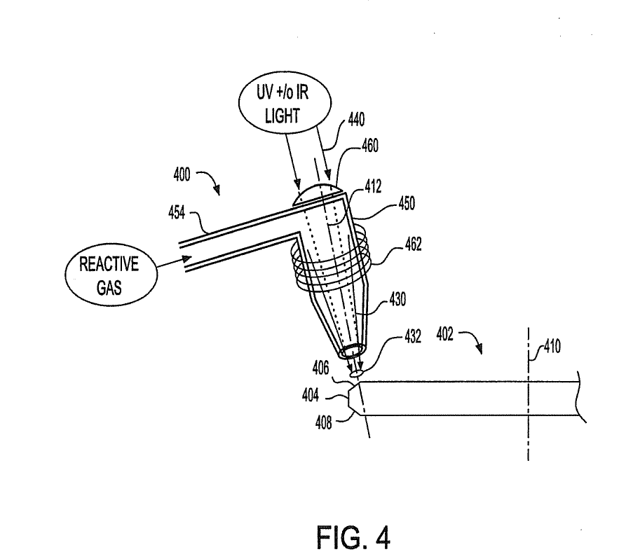

The action of the reactive gas 130 on the film being removed can be enhanced by heating the gas(es) immediately prior to the gas(es) impinging on the wafer. This is discussed in greater detail hereinbelow with respect to the embodiment of FIG. 4.

The action of the reactive gas(es) 130 can also be enhanced by a beam 140 of radiation which is ultraviolet (UV) and/or infrared (IR) light directed at (e.g., focused upon) the reactive zone 132. When the wafer 102 is rotated, the impinging reactive gas(es) 130 and beam(s) 140 of light will treat the entire edge region of the wafer.

It is within the scope of the invention that, rather than rotating the wafer 102, the wafer 102 can remain stationary, and a system for delivering the gas(es) 130 and beam(s) 140 of light (“gas/light delivery system”, such as described hereinbelow with respect to FIG. 4) can be moved around the periphery of the wafer 102. However, in such a case the apparatus of the gas delivery system would be more complicated since the gas connections would also have to rotate.

As best viewed in FIG. 1, the gas(es) 130 are directed at the reactive zone 132 along a “gas delivery” axis 112 which is inclined at an angle of θ (theta) with respect to the wafer's axis of rotation 110. The axis of rotation 110 is (by definition) normal to the plane of the wafer 102. The gas-delivery axis 112 may also be normal to the axis of rotation 110 (in which case θ would be zero) or it may be inclined, as shown, with respect to the axis of rotation 110. A suitable range of inclination for the axis 112 is 0-60 degrees, such as 30-60 degrees, such as approximately 45 degrees. The angle can be determined empirically, depending on the application and the area to be treated. In most cases 45 degrees would be a reasonable starting point.

In FIG. 1, the gas(es) 130 are directed at the reactive zone 132, in an orientation that is inclined slightly towards the center of the wafer. In such a case, theta is positive. The axis 112 can also be inclined so that the gas(es) 130 are directed at the same reactive zone 132, but in an orientation that directs gas(es) away the center of the wafer, in which case that would be negative. Again, the angle can be determined empirically, depending on the application and the area to be treated. A suitable range of inclination for the axis 112 would be −0 to −60 degrees, such as −30 to −60 degrees, such as approximately −45 degrees. (Taking the last two paragraphs together, the angle of inclination is between plus and minus 60 degrees with respect to the axis of rotation.) The angle (inclination, positive or negative, and magnitude) of the gas delivery (i.e., the axis 112) can be determined by the work to be done—for example, toward the bevel (as illustrated) to clean it, toward the circumference (edge) to clean the top (or bottom) perimeter of the wafer.

In FIG. 1, it is suggested (although not specifically stated) that the axis 112 is in the same plane as the axis 110—both are in the plane of the drawing sheet—and that the axis 112 remains in this plane irrespective of its inclination, whether positive or negative. It is within the scope of the invention that the axis 112 can also be tilted, out-of-plane (i.e., the plane established by the two axes 110, 112), with respect to the axis 110. This becomes relevant when taking into consideration that the wafer is rotating and the reactive zone is moving (counterclockwise) around the circumference of the wafer. For example, the axis 112 can be tilted so that the gas(es) 130 impinge the reactive zone 132 in a direction which will cause the gases to flow either ahead of (negative tilt) or behind (positive tilt) the reactive zone. By tilting the axis 112 so that the gas(es) impinge then flow ahead of the reactive zone, the area immediately ahead of the reactive zone is “pre-treated”. By tilting the axis 112 so that the gas(es) impinge then flow behind the reactive zone, the area immediately behind the reactive zone can be cleared of debris (volatiles), if any. The tilt angle can be determined empirically, depending on the application and the area to be treated. A suitable range of tilt for the axis 112 would between 0 and +/−60 degrees, such as approximately 30 degrees.

In FIG. 2, the reactive zone 132 is shown as being a circular area. This, of course, would be the case, generally, when the axis 112 is normal to the surface of wafer 102 (excluding the distortion effect upon the circle as it impacts the bevel). When, however, the angle of the axis 112 varies from 90 degrees, in either inclination or in tilt (as discussed above), the reactive zone would become elliptical, with increasing length with increasing angle of inclination or tilt of the gas delivery system.

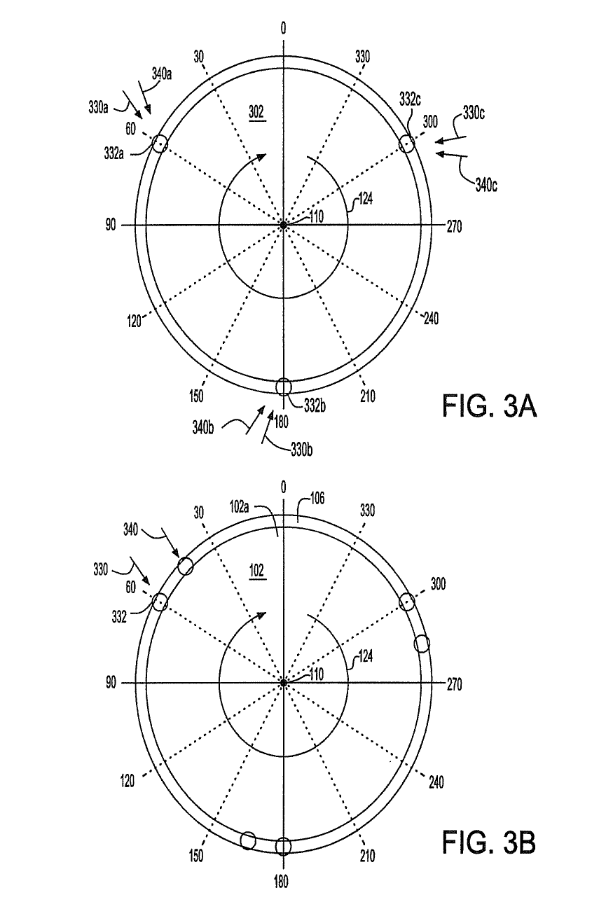

It is within the scope of the invention that multiple gas/light delivery systems can cause multiple streams 330a, 330b, 330c (compare 130) of gas(es) and corresponding multiple beam(s) 340a, 340b, 340c (compare 140) of light to impinge on multiple reactive zones 332a, 332b, 332c disposed at circumferentially spaced-apart locations in the edge region of the wafer 302 (compare 102), as shown in FIG. 3A. For example, three reactive zones 332a, 332b, 332c can be evenly-spaced 120 degrees apart from one another, around the circumference (e.g., edge) of the wafer 302, as shown in FIG. 3A. (Alternatively, the multiple reactive zones can be unevenly spaced about the circumference of the wafer.) Such a system can be useful for various purposes, including:(1) Performing a given treatment multiple (e.g., 3) times, such as in a single rotation of the wafer or in multiple rotations of the wafer.

(2) Performing a sequence of dissimilar treatments with one setup, such as in a single rotation of the wafer. (With multiple rotations, the sequence of dissimilar treatments may or may not be appropriate to repeat.) This may be appropriate in the case of clearing a “stack” of films.

(3) Increasing throughput by working on more than one area (reactive zone) of the wafer at the same time.

Performing multiple treatments at multiple reactive zones spaced (i.e., at the same radius) about the circumference of the wafer can be relatively straightforward when the reaction of a first one of reactive gases occurs sufficiently rapidly as to clear and allow the reactants of the next reactive gas(es) to then react with a subsequent film or a subsequent portion of the same film.

It is within the scope of the invention that the beam(s) of light 340 can be directed at an area 334 within the edge region which is rotationally slightly in advance of the reactive zone 332, as shown in FIG. 3B. This technique essentially amounts to preheating a small area of the edge region immediately before (rather than contemporaneously/simultaneously with) treating the reactive zone with reactive gas(es). In FIG. 3B, the light 340 is shown “leading” the reactive zone 332 by approximately 15 degrees, for illustrative clarity. Preferably the light area 334 is circumferentially adjacent (but leading) the reactive zone 332. This technique of preheating a small area of the edge region immediately before treating the reactive zone with reactive gas(es) may be employed using one or more of multiple gas/light delivery systems such as described hereinabove with respect to FIG. 3A. Also, this technique of preheating a small area of the edge region immediately before treating the reactive zone with reactive gas(es) can be applied in conjunction with (i.e., in addition to, using an additional light source) directing light and gas at the same spot; for example, IR light could be used to preheat (increase the film temperature in) an area immediately before the reactive zone, and UV light can be directed (focused) at the reactive zone (at the point of reaction) to enhance the reaction. (If, as suggested, focusing is involved, it can be useful to separate the IR from the UV, because different optics may be required for these different wavelengths of light).

In the examples above, only the front surface of the wafer is treated. It is within the scope of this invention that both the front (102a) and back (102b) surfaces of the wafer are treated, particularly in the edge region. In such a case, the backside (102b) would be treated with another gas/light delivery system such as has been described hereinabove, including all the variations thereof. The reactive zone(s) on the backside can be at the same or different circumferential position(s) from the reactive zone(s) on the front side, there can be a different number of them, and they can be either of substantially the same or a different size (area) than the reactive zone(s) on the front side, and any combination thereof.

Unlike the process in the aforementioned U.S. Pat. No. 6,546,938, the process of the present invention utilizes reactive gas at atmospheric pressure, rather than a plasma. This is advantageous (among other things) because it is difficult to maintain a plasma at atmospheric pressure. Plasmas at atmospheric pressure consume large amounts of power and either make small reactive gas jets (capacitively coupled plasmas) or very large plasma jets (inductively coupled plasmas).

The invention is primarily directed to removing residual process films that have volatile byproducts. It is generally not suited to removing copper, as in the aforementioned U.S. Pat. No. 6,546,938. Since the byproducts are volatile, there is no rinsing involved, and cleaning between steps is not necessary. This last point is important when performing multiple (e.g., a sequence of) treatments on the wafer, as in FIG. 3B. The process of the present invention is “self-cleaning”.

FIG. 4 illustrates an embodiment of a spray nozzle assembly 400, for practicing the present invention with a semiconductor wafer 402 (compare 102). The wafer 402 is shown having an outer edge 404 (compare 104), an upper bevel 406 (compare 106) and a lower bevel 408 (compare 108). The spray nozzle assembly 400 functions as a gas/light delivery system as described hereinabove; that is, a system for delivering a stream 430 (compare 130) of one or more reactive gas(es) and a beam 440 (compare 140) of ultraviolet (UV) and/or infrared (IR) light directed at (e.g., focused upon) a reactive zone 432. In this example, a reactive zone 432 is illustrated as being just in front of the surface of the wafer, rather than on the wafer (compare 132) for illustrative clarity.

When the wafer 402 is rotated, the impinging reactive gas(es) 430 and beam(s) 440 of light will treat an entire edge region of the wafer, as described hereinabove. An axis of rotation 410 (compare 110) is shown, as well as a “gas delivery” axis 412 (compare 112) which is inclined at an angle of θ (theta) with respect to the wafer's axis of rotation 410.

The spray nozzle assembly 400 is representative of one of what can be multiple gas/light delivery systems for delivering multiple streams and beams, including at multiple reactive zones on one side of the wafer as well as to both the front and back sides of the wafer, as discussed hereinabove.

The spray nozzle assembly 100 comprises a cylindrical pipe 450 having two ends; one end disposed towards (proximal) the wafer, another end disposed away from (distal) the wafer. The cylindrical pipe 150 has an axis which is the gas delivery axis 412. The pipe 450 suitably has a diameter of 2-10 mm, and a length of 10-30 mm.

A tapered (e.g., frusto-conical) nozzle 452 is disposed at the proximal end of the cylindrical pipe 450, and is coaxial with the cylindrical pipe 450. The nozzle 452 is tapered, and has an output orifice disposed towards (proximal) the wafer. The nozzle 452 suitably has a length of 5-10 mm. The output orifice suitably has a diameter of 0.5 mm to 5 mm. The nozzle 452 is for directing reactive gas from the cylindrical pipe 450 to a reactive zone on the wafer.

A gas supply tube 454 is in fluid communication with the pipe 450, such as connected at right angles to the side of the pipe 450 near the distal end of the pipe 450. The connection angle may be chosen as convenient. The tube 454 may be integrally formed with the pipe 450. The supply tube 454 is for supplying reactive gas to the cylindrical pipe 450.

A lens 460 is disposed at the distal end of the pipe 450 which, if the distal end of the pipe 450 is otherwise open, can seal off the distal end of the pipe 450. The lens 460 is used for focusing IR and/or UV light onto (at) the reactive zone 432. The UV or IR radiation increases the reactivity of the gases by either increasing the reactivity of the gases directly or the film (not shown) or through increased localized temperature of the film, as discussed hereinabove.

The lens, the light source, and whatever means are necessary to allow a beam of radiation to enter the cylindrical pipe and exit the nozzle at the reactive zone constitute means for directing a beam of radiation selected from at least one of the group consisting of ultraviolet (UV) light and infrared (IR) light at the reactive zone.

If the distal end of the pipe is open, as described above, this is generally not a problem to get light into the pipe. If necessary to allow the light to get into and through the nozzle 452, the nozzle 452 can be made of UV/IR transparent glasses, sapphire, fused silica, etc. Also, if the distal end of the pipe 450 is not open and needs to be transparent, it can be made of these same materials. Regarding the latter, this can be avoided if the tube 454 is joined in a non-light-obscuring manner to the pipe 450.

A resistive heater 462 is disposed about the pipe 450. Gas is directed through the supply tube 452 to the pipe 450. The incoming gas can be heated to near its desired temperature before entering the pipe 450, and further “adjusted” to a final temperature by the resistive heater 462 just before exiting via the nozzle 452. The combination of gas heated to a desired temperature plus the enhancing influence of the UV or localized heating influence of the IR radiation dramatically increases the reactivity of the gas impinging on the film (not shown) on the wafer.

With regard to heating the gas before impinging on the reactive zone, as well as the concept of directing IR at (or before) the reactive zone, the above-described approach offers several distinct advantages. For example: Organofluoropolymers are known to react with oxygen; the reaction rate is slow at room temperature but much higher at higher temperature. Heating the entire wafer is not always practical or desirable due to the material limitation of the semiconductor structure. Heating the fluoropolymer only where reactive oxygen is present is preferable. UV light coupled with ozone in an inert gas such as argon can be used to increase the removal rate of organopolymers. IR radiation can be focused through the nozzle to locally heat the zone to have the organopolymer removed. Inorganic films can also be removed in such the same manner by using gases known to react with silicon dioxide, carbon doped silicon oxide, silicon nitride, silicon carbide and nitrogen doped silicon carbide plus some metal films like titanium and tantalum nitride.

In operation, the wafer 402 is rotated about its axis 410 and the gas flow is started, heaters are turned on and either or both the UV and IR radiation is turned on. The film to be removed (not shown) is removed as the wafer is rotated under the reactive zone 432. When numerous films are present and both sides of the wafer and the bevel need to be treated multiple nozzles can be used, as described hereinabove. This arrangement allows removing the films in sequence without breaking up the operation into discrete treatments. A multiple nozzle arrangement can be made to treat all three zones at once, as described hereinabove.

The resistive heater 462 is disposed just before the tapered nozzle 452 and is used to adjust the temperature of the gas(es) just prior to impinging onto the film. In this manner, degradation of the incoming reactants can be minimized. (If the incoming gases were heated at the supply, or in the supply tube 454, they could degrade.) Also, the heater 462 may serve to increase the gas temperature so that as the gas(es) impinges onto the bevel 406, polymer temperature reduction due to Venturi effects can be compensated for.

During normal operation the wafer 402 is rotated about its central axis 410 at a rate that the unwanted film is removed. Adding additional nozzles to the assembly provides for faster throughput and selective removal of the films as they become exposed after the outer film is removed. One or more of the assemblies is used during normal removal of the unwanted films. The reactive zone created by positioning the assembly near the perimeter or bevel edge of the wafer can be used to remove the unwanted film over the entire perimeter or bevel of the wafer by rotating the wafer about its center point. The rate of rotation is determined by the reactivity of the impinging gaseous reactants and the localized heating from the heated gas, UV and IR radiation and the energy released from the reaction of the gas with the film.

Several assemblies can be employed and positioned at different locations around the wafer perimeter or bevel to increase the removal rate of the film or to remove an underlying film. For example, if there are four films to be removed, four assemblies can be employed and spaced evenly about the perimeter of the wafer. The assembly to remove the top lying film is started and the wafer rotation is begun such that the upper film layer is removed and a lower film is now exposed. This freshly exposed film is removed as it passes under the second assembly. The third and fourth films are removed in the same sequence and manner as the first two. The difference between the four conditions, i.e., gases, temperature and UV or IR radiation, is determined by the composition of the film.

Organic films can be removed by reaction with oxygen. The rate of removal is strongly influenced by the temperature of the film and oxygen free radical or ion concentration. Increasing the temperature of both the oxygen and film increases the rate of removal. The temperature of the impinging oxygen can increase the reactivity by increasing the dissociation of the oxygen. Ozone can be used rather than oxygen to further increase the amount of reactive oxygen free radicals and ions. Adding UV radiation also increases the dissociation and reactivity of the oxygen. Other gases can be added as necessary or desired to improve the reaction and remove films that may lie on or under the bevel polymer. Focusing IR radiation onto the film can increase the reactivity of the film by locally increasing the film temperature.

Other films can be removed by using an appropriate reactant gas along with UV and IR radiation to both dissociate the reactant and to locally heat the film. Gases for removal of commonly employed dielectrics include NF₃, CF₄, CHF₃, CH₂F₂, HF, F₂, Cl₂, HBr etc. The dissociation of these gases releases very reactive species, F⁻, Cl⁻ and Br⁻, and special precautions are needed to sweep the reactant and byproducts away from the wafer device area. As with using an Ar/O₂ reactant condition, the wafer and assembly must be carried out in a controlled environment such as an enclosed chamber, that may require the ambient atmosphere to be Ar, He, or N₂.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. An apparatus for treating an edge region of a semiconductor wafer comprising:
means for directing a stream of at least one reactive gas along a gas-delivery axis at a reactive zone on a front side of the wafer;
means for rotating the wafer about an axis of rotation so that the reactive zone travels circumferentially around the wafer until the entire edge region of the wafer has been treated by the at least one reactive gas; and
means for heating the at least one reactive gas prior to directing the stream at the reactive zone on the wafer.

2. An apparatus according to claim 1, further comprising means for directing a beam of radiation selected from at least one of the group consisting of ultraviolet (UV) light and infrared (IR) light at the wafer.

3. An apparatus according to claim 1, farther comprising additional means for directing a stream of at least one additional reactive gas along a gas-delivery axis at an additional reactive zone on a back side of the wafer; and
additional means for heating the at least one additional reactive gas prior to directing the stream at the reactive zone on the wafer,
wherein the additional reactive zone travels circumferentially around the wafer until the entire edge region of the wafer has been treated by the at least one additional reactive gas.
